(19) United States
(12) Patent Application Publication
(10) Pub. No.: US 2007/0087700 A1
(43) Pub. Date: Apr. 19, 2007

(54) Radio base station, communications program and communications method

(75) Inventor: Toshio Tanida, Anpachi-gun (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 11/543,226

(22) Filed: Oct. 5, 2006

(30) Foreign Application Priority Data
Oct. 5, 2005 (JP) P2005-292396

(51) Int. Cl. H04B 1/02

(52) U.S. Cl. 455/101

(57) ABSTRACT

A radio base station of the present invention includes a vacant channel quantity monitor and a channel controller. The vacant channel quantity monitor monitors whether or not the number of vacant channels, which is the number of channels not in use, reaches a predetermined threshold value. The channel controller releases at least a part of the channels being used for diversity radio communications, in a case where vacant channel quantity monitor detects the number of vacant channels reaches the predetermined threshold value.

### CROSS-REFERENCE TO RELATED APPLICATIONS

This application is based upon and claims the benefit of priority from the prior Japanese Patent Applications No. P2005-292396, filed on Oct. 5, 2005; the entire contents of which are incorporated herein by reference.

### BACKGROUND OF THE INVENTION

1. Field of the Invention

The present invention relates to a radio base station, a communications program and a communications method which carry out diversity radio communications with mobile stations by using plural channels defined by time slots and radio frequencies.

2. Description of the Related Art

In a radio communications system in which time division multiple access (TDMA) is used, such as the PHS (personal handyphone system), so-called “tuner diversity” is implemented. The tuner diversity is a scheme of carrying out diversity radio communications between a radio base station (CS) and a mobile station (PS) by using plural channels (combination of time slots and radio frequencies.) Generally, by use of the tuner diversity, the quality of receiving communication can be improved.

In a case where vacant time slots for allocating a new call to the mobile station is not enough when a call activating the tuner diversity exists, the tuner diversity for the call is released to secure a time slot to be allocated to the new call. This technology is described, for instance, in Japanese Unexamined Patent Publication No. 2005-150969, pp. 8-10, and FIG. 5.

However, the conventional method of activating and deactivating the tuner diversity mentioned above has a problem. Specifically, the allocation of a time slot to a new call requires a search for radio frequencies not in use, but no time can be secured for the search when all time slots in a frame are in use. This makes it impossible to detect the radio frequencies not in use. This results in the problem of being unable to allocate the time slot to the new call.

This problem may also arise in a case where a channel (or a time slot), which has become not in use due to the release of the tuner diversity for plural existing calls, is reallocated to any one of the calls.

The conventional method also has the problem of having an extremely low degree of flexibility in allocating a time slot to a new call because the time slot to be allocated to the new call depends on the usage of the time slots being used for existing calls.

### SUMMARY OF THE INVENTION

The present invention has been made in consideration for the above-described problems. It is an object of the present invention to provide a radio base station, a communications program and a communications method, which are capable of allocating a channel to a new call with higher reliability even in a case where there are a large number of calls, while using the tuner diversity to ensure the quality of receiving communication.

To solve the foregoing problems, the present invention has aspects as given below. A first aspect of the present invention is a radio base station (CS100) which carries out diversity radio communications (tuner diversity) with a mobile station (e.g., PS200A) by using plural channels defined by time slots and radio frequencies. The radio base station includes a vacant channel quantity monitor (controller 130) configured to monitor whether or not the number of vacant channels, which is the number of channels not in use, reaches a predetermined threshold value, and a channel controller (controller 130) configured to release at least a part of the channels being used for the diversity radio communications in a case where the vacant channel quantity monitor detects that the number of vacant channels reaches the predetermined threshold value.

According to the first aspect, the radio base station activates the diversity radio communications until the number of vacant channels reaches the predetermined threshold value. The radio base station thus can ensure a predetermined quality of receiving communication. Moreover, the radio base station releases at least a part of channels being used for the diversity radio communications, in a case where the number of vacant channels reaches the predetermined threshold value. The radio base station thus can allocate a channel to a new call with higher reliability even in a case where there are a large number of calls.

A second aspect of the present invention is the radio base station according to the first aspect of the present invention and has a feature as follows. The channel controller determines a channel to be released based on a receiving communication quality of a signal received from the mobile station.

A third aspect of the present invention is the radio base station according to the second aspect of the present invention and has a feature as follows. In a case where the diversity radio communications are activated with a plurality of mobile stations (e.g., PS200A and PS200B), the channel controller selects a mobile station having a highest average of the receiving communication quality of signals received through channels allocated to the plurality of mobile stations respectively, and the channel controller releases a channel of which the receiving communication quality is lowest within the plurality of channels being used with the selected mobile station.

A fourth aspect of the present invention is a communications program used on a communications device for carrying out diversity radio communications with a mobile station by using a plurality of channels defined by time slots and radio frequencies. The communications program causing the communications device to execute a vacant channel quantity monitoring procedure for monitoring whether or not the number of vacant channels, which is the number of channels not in use, reaches a predetermined threshold value, and a channel controlling procedure for releasing at least a part of the channels being used for the diversity radio communications, in a case where it is detected that the number of vacant channels reaches the predetermined threshold value at the vacant channel quantity procedure.

A fifth aspect of the present invention is the communications program according to the fourth aspect of the present invention and has a feature as follows. The channel controlling procedure includes determining a channel to be released based on a receiving communication quality of a signal received from the mobile station.

A sixth aspect of the present invention is the communications program according to the fifth aspect of the present invention and has a feature as follows. In a case where the diversity radio communications are activated with a plurality of mobile stations, the channel controlling procedure includes selecting a mobile station having a highest average of the receiving communication quality of signals received through channels allocated to the plurality of mobile stations respectively, and releasing a channel of which the receiving communication quality is lowest within the plurality of channels being used with the selected mobile station.

A seventh aspect of the present invention is a communications method for carrying out diversity radio communications with a mobile station by using a plurality of channels defined by time slots and radio frequencies. The communications method includes the steps of monitoring whether or not the number of vacant channels, which is the number of the channels not in use, reaches a predetermined threshold value, and releasing at least a part of the channels being used for the diversity radio communications, in a case where it is detected that the number of vacant channels reaches the predetermined threshold value at the monitoring step.

An eighth aspect of the present invention is the communications method according to the seventh aspect of the present invention and has a feature as follows. The releasing step includes determining a channel to be released based on a receiving communication quality of a signal received from the mobile station.

A ninth aspect of the present invention is the communications method according to the eighth aspect of the present invention and has a feature as follows. In a case where the diversity radio communications are activated with a plurality of mobile stations, the step of releasing the channel includes selecting a mobile station having a highest average of the receiving communication quality of signals received through channels allocated to the plurality of mobile stations respectively, and releasing a channel of which the receiving communication quality is lowest within the plurality of channels being used with the selected mobile station.

The aspects of the present invention enable providing the radio base station, the communications program and the communications method, which are capable of allocating a channel to a new call with higher reliability even in a case where there are a large number of calls, while using the tuner diversity to ensure the quality of receiving communication.

### BRIEF DESCRIPTION OF THE DRAWINGS

FIG. 1 is a schematic view of the overall configuration of a radio communications system including a radio base station according to an embodiment of the present invention.

FIG. 2 is a functional block diagram of the radio base station according to the embodiment of the present invention.

FIG. 3 is an operational flowchart showing an operation flow for channel allocation by the radio base station according to the embodiment of the present invention.

FIG. 4 is another operational flowchart showing of an operation flow for channel allocation by the radio base station according to the embodiment of the present invention.

FIG. 5 is illustration showing as an example of the state of channel allocation performed by the radio base station according to the embodiment of the present invention.

FIG. 6 is an operational flowchart showing an operation flow for selecting a channel to be released, which is performed by the radio base station according to the embodiment of the present invention.

FIG. 7 is another operational flowchart showing an operation flow for selecting a channel to be released, which is performed by the radio base station according to the embodiment of the present invention.

### DESCRIPTION OF TEE PREFERRED EMBODIMENTS

The description will now be given with regard to an embodiment of the present invention. In the following description of the drawings, the same or similar parts are designated by the same or similar reference numerals. It should be noted that the drawings are schematic and dimensional ratios and others therein are different from actual ones.

It is to be therefore understood that specific dimensions and others should be determined in consideration of the description given below Of course, it is to be also understood that there may be a difference in the relation or ratio between dimensions in the drawings.

(Overall Schematic Configuration of Radio Communication System Including Radio Base Station)

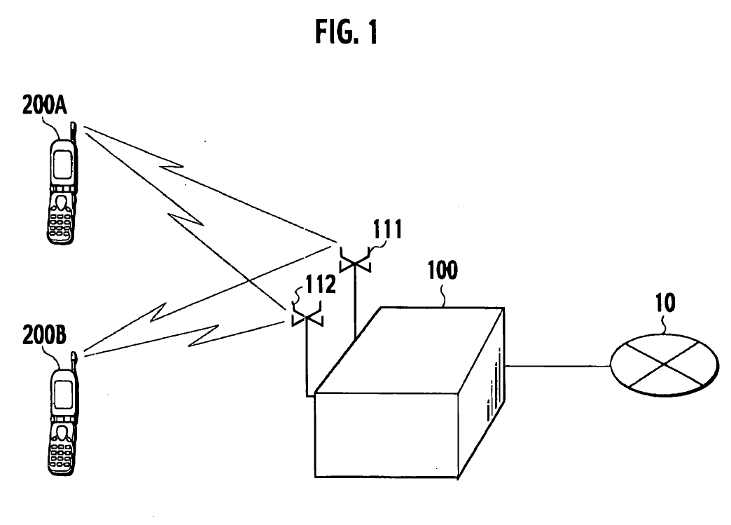

FIG. 1 is a schematic view of the overall configuration of a radio communications system including a radio base station according to the embodiment of the present invention. The radio communications system is in conformity with PHS (personal handyphone system) standards. In the radio communications system, time division multiple access (TDMA) and time division duplex (TDD) are used.

In the embodiment, the radio communications system is configured of a radio base station 100 (hereinafter abbreviated as “CS100” as appropriate) and mobile stations 200A and 200B (hereinafter abbreviated respectively as “PS200A” and “PS200B” as appropriate.) Incidentally, it is to be understood that the numbers of radio base stations and mobile stations to constitute the radio communications system are not limited to those shown in FIG. 1.

The CS100 is capable of performing diversity radio communications, so-called “tuner diversity,” with the PS200A and PS200B by using plural channels defined by time slots and radio frequencies. The CS100 has two antennas 111 and 112, each of which is an array antenna. In addition, the CS100 is connected to a communications network 10.

The communications network 10 serves to provide an interconnection among plural radio base stations. In the embodiment, the communications network 10 is configured of an ISDN (integrated services digital network) circuit (or an I′ circuit) or the like. Incidentally, the communications network 10 may be a packet switched communications network (e.g., an IP network), rather than a circuit switched communications network such as the ISDN circuit.

(Configuration of Functional Blocks of Radio Base Station)

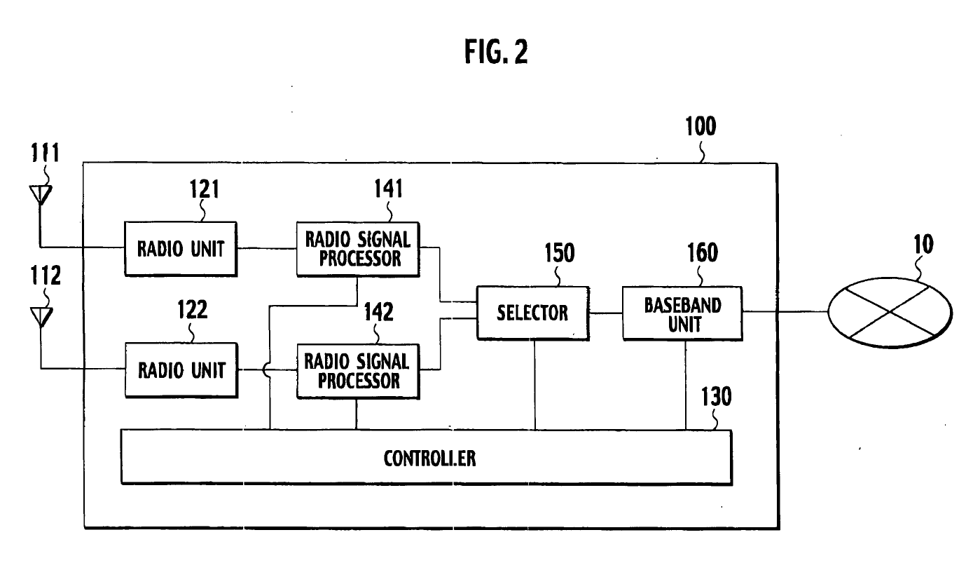

FIG. 2 is a functional block diagram of the configuration of the CS100. As shown in FIG. 2, the CS100 includes antennas 111 and 112, radio units 121 and 122, a controller 130, radio signal processors 141 and 142, a selector 150, and a baseband unit 160.

The antenna 111 is configured of an array antenna which transmits and receives radio signals with a frequency of 1.9 GHz band. The antenna 111 is connected to the radio unit 121.

The radio unit 121 generates the radio signals with the frequency of 1.9 GHz band, and transmits the radio signals through the antenna 111. The radio unit 121 also receives the radio signals with the frequency of 1.9 GHz band from the PS200A and PS200B through the antenna 111. Incidentally, the antenna 112 and the radio unit 122 have the same functions as the antenna 111 and the radio unit 121, respectively.

The controller 130 is connected to the radio signal processors 141 and 142, the selector 150, and the baseband unit 160.

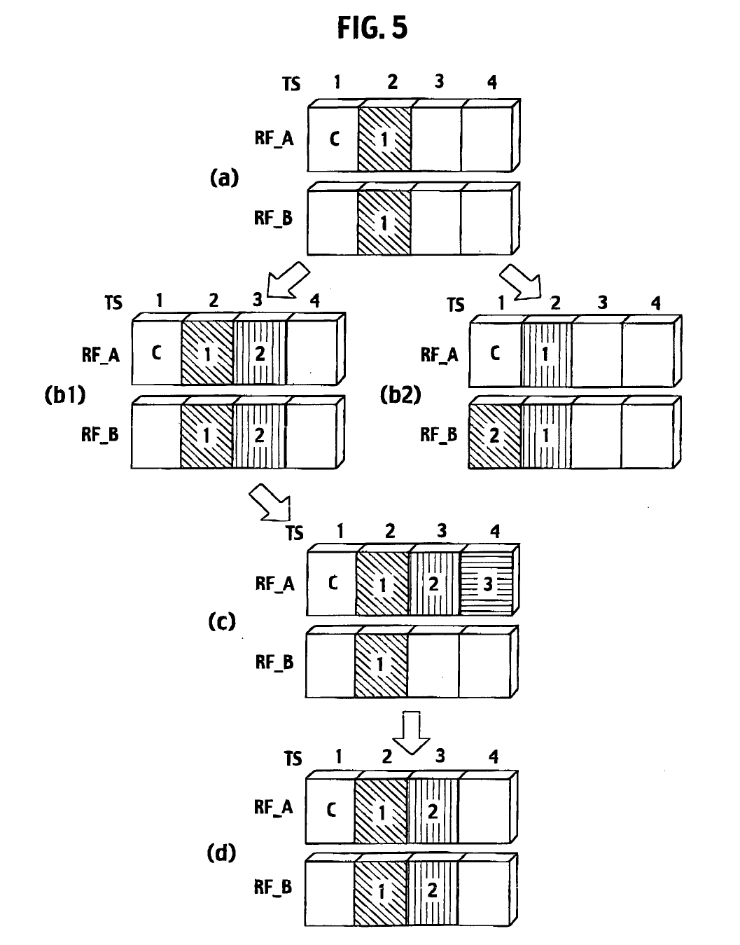

The controller 130 performs control on the allocation of channels which are respectively defined by combinations of time slots and radio frequencies (as shown for example in FIG. 5.) The controller 130 also monitors on the number of vacant channels which are not being used for communications respectively with the PS200A and PS200B. Moreover, the controller 130 controls activation and deactivation of the tuner diversity (TD), and so on.

More specifically, in the embodiment, the controller 130 monitors whether or not the number of vacant channels reaches a predetermined threshold value.

When the controller 130 detects that the number of vacant channels reaches the predetermined threshold value, the controller 130 releases a part of the channels being used for the tuner diversity. In the embodiment, the controller 130 constitutes a vacant channel quantity monitor and a channel controller.

The controller 130 computes a receiving communication quality of signals received from each of the PS200A and PS200B, such as a frame error rate (FER) and received signal strength (RSSI.) The controller 130 stores the obtained FER and RSSI values The controller 130 then determines a channel to be released based on the FER and RSSI.

When the tuner diversity is activated for communications with plural mobile stations (e.g., the PS200A and PS200B), the controller 130 selects a mobile station having the highest average of receiving communication quality of the signals received through channels which have been allocated to the plural mobile stations respectively.

Moreover, the controller 130 releases a channel having the lowest receiving communication quality among plural channels being used between the radio base station and the selected mobile station. Incidentally, the description will be given later with regard to a specific method for determining a channel to be released.

The radio signal processor 141 is connected to the radio unit 121 and the selector 150. The radio signal processor 141 has a DSP (digital signal processor) and performs digital modulation and demodulation on a baseband signal.

The radio signal processor 142 has the same function as that of the radio signal processor 141. The radio signal processor 142 is connected to the radio unit 122 and the selector 150.

The selector 150 makes a selection from a system extending from the radio unit 121 to the radio signal processor 141 and a system extending from the radio unit 122 to the radio signal processor 142. The selector 150 selects one of these systems, which has the better receiving communication quality. Specifically, the selector 150 selects the system having higher receiving communication quality (e.g., the FER) according to control of the controller 130.

The baseband unit 160 performs processing on a baseband signal (e.g., attachment and detachment of various pieces of information such as a base station identification code (CSID).) The baseband unit 160 includes a network interface for a connection to the communications network 10.

(Operation of Radio Communications System)

The description will now be given with regard to the operation of the radio communications system according to the embodiment mentioned above. Specifically, the description will be given with regard to (1) an operation for allocating channels (or time slots and radio frequencies) for communications with the mobile station, and (2) the operation for determining a channel to be released in a case where the tuner diversity is activated.

Incidentally, the description will be given below taking as an example a channel configuration having 1C7T, that is, one control channel (C) and seven communications channels (T) (see FIG. 5.) In addition, the time slot will be abbreviated simply as a “slot” as appropriate.

(1) Operation for Allocating Channels

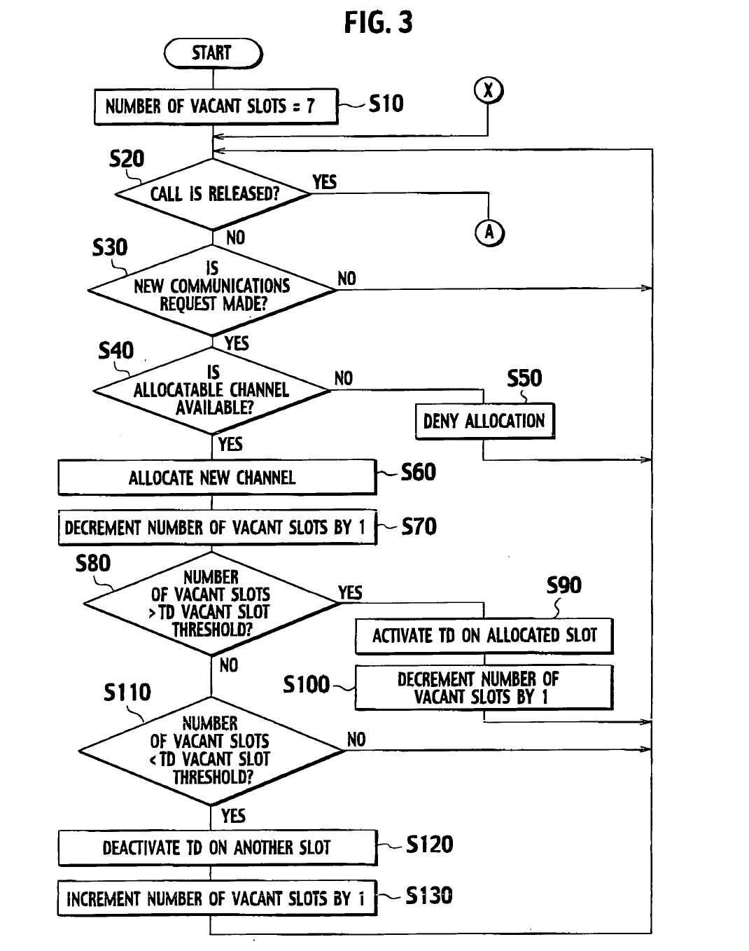

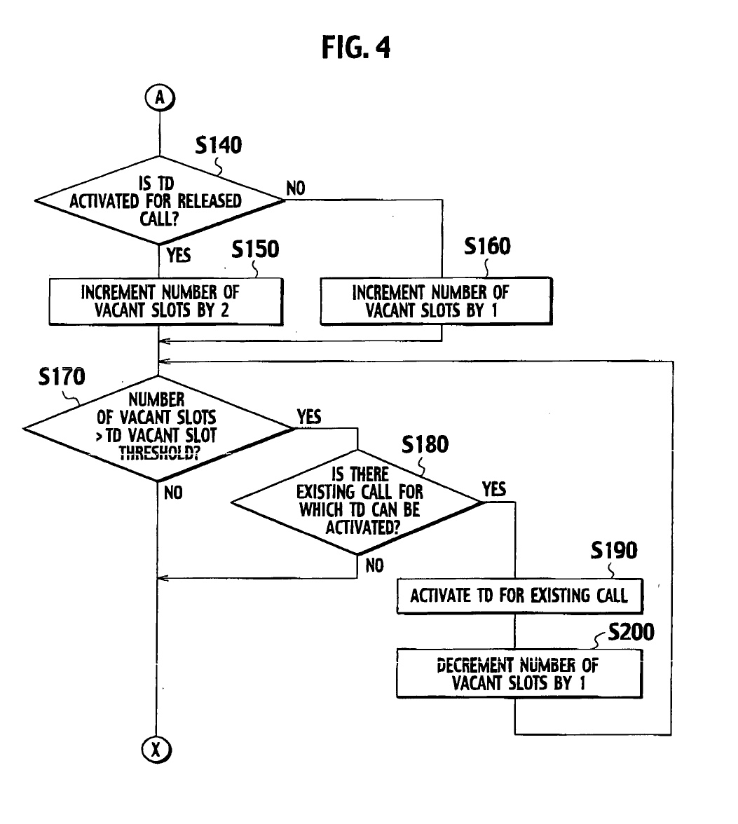

FIGS. 3 and 4 show an operation flow for allocating channels (or time slots and radio frequencies) used for communications with the mobile station.

In step S10, the CS100 recognizes that the number of vacant slots (or the number of vacant channels) is equal to 7, that is, there is no channel being used for communications with the mobile station.

In step S20, the CS100 determines whether or not a call allocated for communications with the mobile station is released.

In a case where the call allocated for communications with the mobile station is released (YES in step S20), the CS100 performs processing in step S140 shown in FIG. 4.

On the other hand, in a case where the call allocated for communications with the mobile station is not released (NO in step S20), in step S30, the CS100 determines whether or not a new communications request with the mobile station has been made.

In a case where the new communications request with the mobile station has been made (YES in step S30), in step S40, the CS100 determines whether or not an allocatable channel is available in response to the new communications request.

On the other hand, in a case where the new communications request with the mobile station has not been made (NO in step S30), the CS100 repeats the processing starting at step S20.

In a case where no allocatable channel is available (No in step S40), in step S50, the CS100 denies channel allocation based on the new communications request.

In a case where the allocatable channel is present (YES in step S40), in step S60, the CS100 newly allocates the channel to the mobile station (e.g., the PS200A) based on the new communications request.

In step S70, the CS100 updates the number of vacant slots because the channel was newly allocated in step S60. For example, in a case where the number of vacant slots is equal to 7, the CS100 decrements 1, and updates the number as 6.

In step S80, the CS100 determines whether or not the number of vacant slots exceeds a “TD vacant slot threshold” (3 is adopted in the embodiment) which the tuner diversity (hereinafter abbreviated as “TD” as appropriate) can be maintained.

In a case where the number of vacant slots exceeds the TD vacant slot threshold (YES in step S80), in step S90, the CS100 activates the TD in the slot allocated in step S60.

Here, FIG. 5 shows an example of the state of channel allocation upon completion of the processing in step S90.

As shown in FIG. 5, in the embodiment, the 1C7T channels are configured by time slots (TS1 to TS4) and radio frequencies (RF_A and RF_B.) When the TD is activated for communications with the mobile station (e.g., the PS200A), the communications are implemented using the different radio frequencies (RF_A and RF_B) on the same slot (e.g., TS2, which is represented by the diagonally shaded areas in FIG. 5 (a).)

In step S100, the CS100 updates the number of vacant slots because the channel was further allocated due to the activation of TD. For example, in a case where the number of vacant slots is equal to 6, the CS100 decrements 1 and updates the number as 5.

In a case where the number of vacant slots is equal to or less than the TD vacant slot threshold (NO in step S80), in step S110, the CS100 determines whether or not the number of vacant slots is less than the TD vacant slot threshold (e.g., in a case where the number of vacant slots is equal to 2 while the TD vacant slot threshold is equal to 3.)

When the number of vacant slots is equal to or more than the TD vacant slot threshold (NO in step S110), or specifically when the number of vacant slots is equal to the TD vacant slot threshold, that is, the number of vacant slots and the TD vacant slot threshold are both equal to 3, the CS100 repeats the processing starting in step S20, because a case where the number of vacant slots exceeds the TD vacant slot threshold has been already excluded in step S80.

On the other hand, in a case where the number of vacant slots is less than the TD vacant slot threshold (YES in step S110), in step S120, the CS100 deactivates the TD on another slot.

Incidentally, the description will be given later with regard to a method of selecting channel to be released in a case where plural TDs are activated.

In step S130, the CS100 updates the number of vacant slots because the CS100 has deactivated the TD. For example, in a case where the number of vacant slots is equal to 2, the CS100 increments 2 and updates the number as 6.

In step S140, as shown in FIG. 4, the CS100 determines whether or not the TD is activated for the released call.

In a case where the TD is activated (YES in step S140), in step S150, the CS100 increments the number of vacant slots by 2. For example, in a case where the number of vacant slots is equal to 3 before the releasing of call, the CS100 increments the number of vacant slots to 5 after the releasing of call.

When the TD is not activated (NO in step S140), in step S160, the CS100 increments the number of vacant slots by 1. For example, in a case where the number of vacant slots is equal is to 3 before the releasing of call, the CS100 increments the number of vacant slots to 4 after the releasing of call.

In step S170, the CS100 determines whether or not the number of vacant slots exceeds the TD vacant slot threshold.

In a case where the number of vacant slots exceeds the TD vacant slot threshold (YES in step S170), in step S180, the CS100 determines whether or not there is an existing call for which the TD can be activated.

In a case where the number of vacant slots is equal to or less than the TD vacant slot threshold (NO in step S170), the CS100 returns to step S20 and performs the processing of step S20.

In a case where there is the existing call for which the TD can be activated (YES in step S180), in step S190, the CS100 activates the TD for the existing call.

In step S200, the CS100 updates the number of vacant slots because the CS100 has activated the TD for another channel allocation.

In a case where there is no existing call for which the TD can be activated (NO in step S180), the CS100 returns to step S20 and performs the processing of step S20.

With reference to FIG. 5, the description will now be given with regard to the state of allocating a channel to communications with the mobile stations by the CS100, which operates in the manner as mentioned above.

(a) shows a state where one TD is activated using the different radio frequencies (RF_A and RF_B) on the same slot (e.g., TS2, which is represented by the diagonally shaded areas in (a).)

When a new call is originated under the state shown in (a), a given channel is allocated to the new call as shown in (b1) or (b2) of FIG. 5.

(b1) shows a state where the TD is also activated for the new call (using RF_A and RF_B in TS3.) (b2) shows a state where only one channel, which is not the TD, is allocated for the new call. As shown in (b2), the same slot as the slot for the control channel (C) can be allocated to the new call in a case where the TD is not activated.

Under the state shown in (b1), the number of vacant slots (or the number of vacant channels) is equal to 3, which is equal to the TD vacant slot threshold described above.

When another new call is originated under this state, the state is changed to a state shown in (c) of FIG. 5. Specifically, a vacant channel (TS4, RF_A) is allocated to the new call without activating the TD for the new call.

Deactivation of the TD on TS3 takes place to provide a vacant channel (TS2, RF_B) in order to maintain the TD vacant slot threshold equal to 3. There are four possible channels which can be released through the deactivation of the TD, specifically, (TS2, RF_A), (TS2, RF_B), (TS3, RF_A), and (TS3, RF_B.) The description will be given later with regard to a method for determining which channel is to be released from among the possible channels.

When the call assigned on TS4 is released under the state is shown (c), the TD is activated again on TS3 as shown in (d) of FIG. 5.

(2) Operation for Determining Channel to be Released

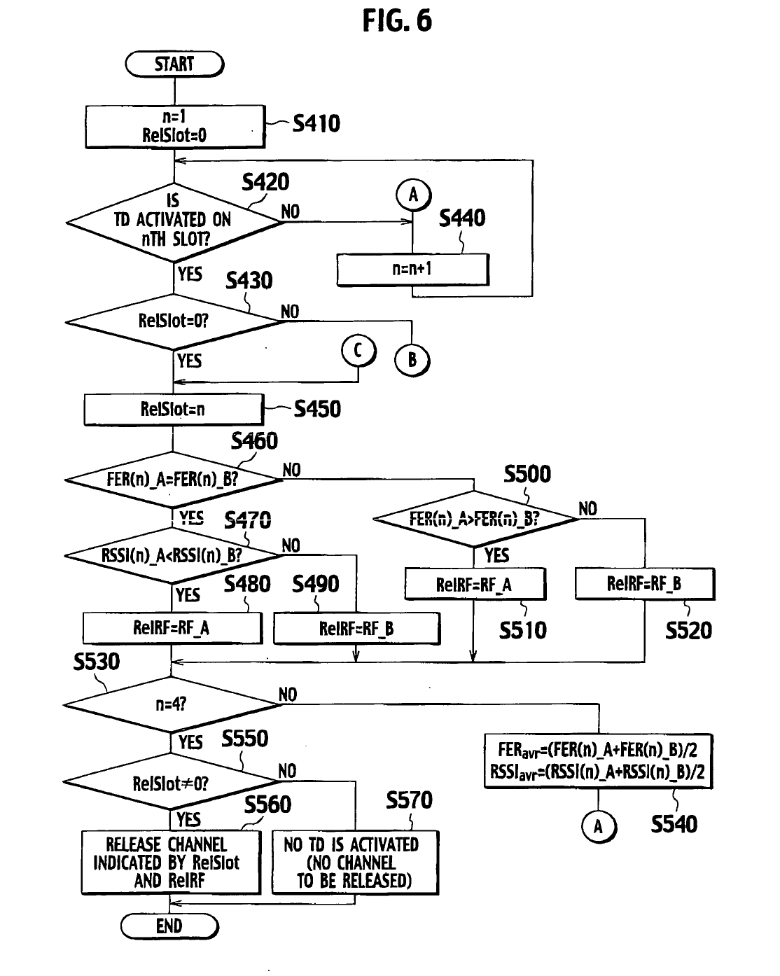

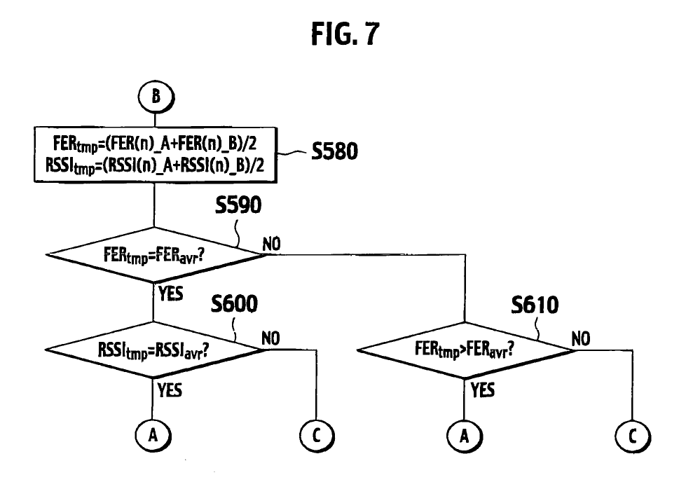

FIGS. 6 and 7 show an operation flow for selecting a channel to be released in a case where plural TDs are activated.

In step S410, the CS100 sets n=1 and RelSlot=0, where n represents the slot number of a slot to be processed, and RelSlot represents the slot number of a slot to be released or the quantity of slots to be released.

In step S420, the CS100 determines whether or not the TD is activated on the nth slot.

In a case where the TD is activated on the nth slot (YES in step S420), in step S430, the CS100 determines whether or not the RelSlot value, that is, the number of slots to be released, is equal to 0.

In a case where the TD is not activated on the nth slot (NO in step S420), in step S440, the CS100 adds 1 to the n value. Then, the CS100 repeats the processing starting at step S420.

In a case where the RelSlot value is equal to 0 (YES in step S430), in step S450, the CS100 updates the RelSlot value.

Specifically, the n value is reflected to the RelSlot value.

In a case where the RelSlot value is not equal to 0 (NO in step S430), the CS100 performs processing in step S580.

In step S460, the CS100 determines whether or not the FER (FER(n)_A) of a RF_A side channel on the nth slot is equal to the FER (FER(n)_B) of a RF_B side channel on the nth slot (e.g., whether or not these channels are error-free.)

In a case where the FER(n)_A is equal to the FER(n)_B (YES in step S460), in step S470, the CS100 determines whether or not the received signal strength (RSSI(n)_A) of the the RF_A side channel on the nth slot is lower than the received signal strength (RSSI(n)_B) of the RF_B side channel on the nth slot.

In a case where the RSSI(n)_A is lower than the RSSI(n)_B (YES in step S470), in step S480, the CS100 determines that the radio frequency (RelRF) of the channel to be released is the RF_A.

In a case where the RSSI(n)_A is equal to or higher than the RSSI(n)_B (NO in step S470), in step S490, the CS100 determines that the radio frequency (RelRF) of the channel to be released is the RF_B.

In a case where the FER(n)_A is not equal to the FER(n)_B (NO in step S460), in step S500, the CS100 determines whether or not the FER(n)_A exceeds the FER(n)_B.

In a case where the FER(n)_A exceeds the FER(n)_B (YES in step S500), that is, in a case where the FER on the RF_A side is lower than the FER on the RF_B side, in step S510, the CS100 determines that the radio frequency (RelRF) of the channel to be released is the RF_A.

On the other hand, in a case where the FER(n)_A is equal to or lower than the FER(n)_B (NO in step S500), in step S520, the CS100 determines that the radio frequency (RelRF) of the channel to be released is the RF_B.

In other words, the CS100 operates in the following manner. When TDs are activated respectively for channels to the mobile station, the CS100 maintains one of the channels, which has the lower FER and which can be judged that the receiving communication quality is good. In a case where the channels having the same FER (e.g., in a case where the channels are error-free), the CS100 maintains one of the channels, which has the higher RSSI and which can be judged that the receiving communication quality is good.

In step S530, the CS100 determines whether or not the n value is equal to 4.

In a case where the n value is not equal to 4 (NO in step S530), or specifically in a case where the n value is less than 4, in step S540, the CS100 calculates the value of FERavr and the value of RSSIavr, where FERavr represents the average of the FERs of the channels for which the TDs are activated, and RSSIavr represents the average of the received signal strengths of the channels. Specifically, the CS100 calculates the FERavr and RSSIavr values based on the following equations (1), and stores the calculated FERavr and RSSIavr values.
FERavr=(FER(n)_{—}A+FER(n)_{—}B)/2
RSSIavr=(RSSI(n)_{—}A+RSSI(n)_{—}B)/2 (1)

In a case where the n value is equal to 4 (YES in step S530), in step S550, the CS100 determines whether or not the RelSlot have a value other than 0.

In a case where the RelSlot value is anything other than 0 (YES in step S550), instep S560, the CS100 releases the channel defined by the slot number indicated by RelSlot (one of the time slots TS1 to TS4) and the radio frequency indicated by RelRF (one of the radio frequencies RF_A and RF_B.)

On the other hand, in a case where the RelSlot value is equal to 0 (NO in step S550), in step S570, the CS100 determines that the TD is not activated. As a result, the CS100 releases no channel.

Moreover, as shown in FIG. 7, in step S580, the CS100 calculates the value of FERtmp and the value of RSSItmp. FERtmp represents the average of the FERs of the nth slot (or channels) determined that the TD is activated based on the processing in step S420 immediately before step S580. RSSItmp represents the average of the received signal strengths of the nth slot (or channels.) Specifically, the CS100 calculates the FERtmp and RSSItmp values based on the following equations (2.)
FERtmp=(FER(n)_{—}A+FER(n)_{—}B)/2
RSSItmp=(RSSI(n)_{—}A+RSSI(n)_{—}B)/2 (2)

In step S590, the CS100 determines whether or not the calculated FERtmp value is equal to the FERavr value stored in step S540 (e.g., whether or not the nth slot is error-free.)

In a case where the FERtmp value is equal to the FERavr value (YES in step S590), in step S600, the CS100 determines whether or not the calculated RSSItmp value is equal to the RSSIavr value stored in step S540.

On the other hand, in a case where the FERtmp value is not equal to the FERavr value (NO in step S590), in step S610, the CS100 determines whether or not the FERtmp value exceeds the FERavr value, that is, whether or not the FERtmp is lower than the FERavr.

Moreover, in a case where the RSSItmp value is equal to the RSSIavr value (YES in step S600), and in a case where the FERtmp value exceeds the FERavr value (YES in step S610), the CS100 returns to step S440 and performs the processing of step S440.

In a case where the RSSItmp value is not equal to the RSSIavr value (NO in step S600), and in a case where the FERtmp value is equal to or less than the FERavr value (NO in step S610), the CS100 returns to step S450 and performs the processing of step S450.

In other words, the CS100 operates in the following manner. When TDs are activated for mobile stations, the CS100 releases the TD for one of the mobile stations, which can be judged as having the lower FER and the better receiving communication quality.

When the mobile stations have the same FER (e.g., when the mobile stations are error-free), the CS100 releases the TD for one of the mobile stations, which can be judged as having the higher RSSI and the better receiving communication quality.

(Function and Effect)

The CS100 according to the embodiment described above activates the tuner diversity (TD) until the number of vacant channels reaches the predetermined threshold value. The CS100 thus can ensure the predetermined receiving communication quality. Moreover, the CS100 releases one of channels being used for the TD, in a case where the number of vacant channels reaches the predetermined threshold value. Accordingly, the CS100 can allocate a channel to a new call with higher reliability even when there are a large number of calls.

Moreover, the CS100 determines a channel to be released based on the receiving communication quality of a signal received from each mobile station (e.g., FER and RSSI.) For this reason, the CS100 can minimize degradation of the receiving communication quality of a signal received from the mobile station, even in a case where the TD for the mobile station is deactivated.

Moreover, in a case where the TD is activated for communications with plural mobile stations, the CS100 of the embodiment selects a mobile station having the highest average of receiving communication quality of the signals received through channels which have been allocated to the plural mobile stations respectively, e.g., the average of the qualities of the channels (TS2, RF_A) and (TS2, RF_B) shown in FIG. 5 (b1), and the average of the qualities of the channels (TS3, RF_A) and (TS3, RF_B) shown therein.

Then, the CS100 releases the channel (e.g., (TS3, RF_B)) having the lowest receiving communication quality, among the plural channels (e.g., (TS3, RF_A) and (TS3, RF_B)) being used between the CS100 and the selected mobile stations.

In other words, the CS100 can more effectively prevent degradation of the receiving communication quality with a mobile station, even in a case where deactivating the TD for the mobile station.

### OTHER EMBODIMENTS

Although the present invention has been disclosed with reference to one embodiment of the present invention as mentioned above, it is to be understood that the present invention is not limited to the descriptions and drawings forming part of the disclosure of the present invention. It will be obvious to those skilled in the art that various alternative embodiments of the present invention are possible in the light of the above teachings.

In the above embodiment of the present invention, the radio base station determines a channel to be released based on the receiving communication quality of the signal received through each channel. Making a decision as to which channel to be released, however, is not necessarily limited to being based on the receiving communication quality. For example, the radio base station may release a channel on a slot assigned a lower slot number.

In the above embodiment of the present invention, the FER and RSSI are used as the receiving communication quality However, other receiving communication qualities, such as the amount of phasing and EVM (error vector magnitude), may be used in place of the FER and RSSI or in addition to the FER and RSSI. Incidentally, the EVM is the magnitude of displacement between the position of a symbol of a received signal and the reference point of the symbol.

In the above embodiment of the present invention, the description has been given taking as an example the channel configuration of 1C7T. However, the channel configuration may be a different configuration, such as a configuration of 1C15T or 2C14T. The number of channels used for the TD may vary and the number may not be 2 channels.

Moreover, the function of the controller 130 mentioned above may be provided in the form of a program which can be executed on a communications device or a computer.

Of course, it will be understood that the present invention is intended to cover other various embodiments which are not described in the description. The scope of the present invention is therefore to be determined solely by the appended claims.

What is claimed is:

1. A radio base station which carries out diversity radio communications with a mobile station by using a plurality of channels defined by time slots and radio frequencies, the radio base station comprising:
a vacant channel quantity monitor configured to monitor whether or not the number of vacant channels, which is the number of channels not in use, reaches a predetermined threshold value; and
a channel controller configured to release at least a part of the channels being used for the diversity radio communications in a case where the vacant channel quantity monitor detects that the number of vacant channels reaches the predetermined threshold value.

2. The radio base station according to claim 1, wherein the channel controller determines a channel to be released based on a receiving communication quality of a signal received from the mobile station.

3. The radio base station according to claim 2, wherein
in a case where the diversity radio communications are activated with a plurality of mobile stations, the channel controller selects a mobile station having a highest average of the receiving communication quality of signals received through channels allocated to the plurality of mobile stations respectively, and
the channel controller releases a channel of which the receiving communication quality is lowest within the plurality of channels being used with the selected mobile station.

4. A communications program used on a communications device for carrying out diversity radio communications with a mobile station by using a plurality of channels defined by time slots and radio frequencies, the communications program causing the communications device to execute:
a vacant channel quantity monitoring procedure for monitoring whether or not the number of vacant channels, which is the number of channels not in use, reaches a predetermined threshold value; and
a channel controlling procedure for releasing at least a part of the channels being used for the diversity radio communications, in a case where it is detected that the number of vacant channels reaches the predetermined threshold value at the vacant channel quantity procedure.

5. The communications program according to claim 4, wherein the channel controlling procedure includes determining a channel to be released based on a receiving communication quality of a signal received from the mobile station.

6. The communications program according to claim 5, wherein in a case where the diversity radio communications are activated with a plurality of mobile stations, the channel controlling procedure includes:
selecting a mobile station having a highest average of the receiving communication quality of signals received through channels allocated to the plurality of mobile stations respectively; and
releasing a channel of which the receiving communication quality is lowest within the plurality of channels being used with the selected mobile station.

7. A communications method for carrying out diversity radio communications with a mobile station by using a plurality of channels defined by time slots and radio frequencies, the communications method comprising the steps of:
monitoring whether or not the number of vacant channels, which is the number of the channels not in use, reaches a predetermined threshold value; and
releasing at least a part of the channels being used for the diversity radio communications, in a case where it is detected that the number of vacant channels reaches the predetermined threshold value at the monitoring step.

8. The communications method according to claim 7, wherein the releasing step includes determining a channel to be released based on a receiving communication quality of a signal received from the mobile station.

9. The communications method according to claim 8, wherein in a case where the diversity radio communications are activated with a plurality of mobile stations, the step of releasing the channel includes:
selecting a mobile station having a highest average of the receiving communication quality of signals received through channels allocated to the plurality of mobile stations respectively; and
releasing a channel of which the receiving communication quality is lowest within the plurality of channels being used with the selected mobile station.
